(19) United States
(12) Patent Application Publication
(10) Pub. No.: US 2006/0179567 A1
(43) Pub. Date: Aug. 17, 2006

(54) Helping hand chair

(76) Inventor: Donna Lee Fell, Kingstowne, VA (US)

Correspondence Address: Donna L. Fell;Blue Skies Visions, 6101 Wigmore Lane, Unit E, Kingstowne, VA, 22315, US

(21) Appl. No.: 11/354,040

(22) Filed: Feb. 15, 2006

Related U.S. Application Data
(60) Provisional application No. 60/653,101, filed on Feb. 16, 2005.

(51) Int. Cl. A61G 7/14

(52) U.S. Cl. 5/86.1

(57) ABSTRACT

A chair that is mobile due to locking rollers located on each of the four legs of the chair. The seated portion or other supporting portions of the chair moves vertically and can be lowered to the floor to access a person who has fallen. The moveable portions are moved via a mechanical device which is easily accessible to the person who has fallen or to anyone assisting the fallen person. The chair is designed with supporting arms, stabilizing bars and safety straps all necessary to ensure the safety of both the person who is in need and/or the person assisting. The location of any remote devices and be placed in a variety of locations to best serve the user to the users specifications. The chair can be equipped with a remote retrieval device and a device for signaling for assistance.

### CROSS-REFERENCE TO RELATED APPLICATIONS

Provisional Patent No. 60/653,101, filed 16 Feb. 2005.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDEX

Not Applicable

### BACKGROUND OF THE INVENTION

This invention is to assist people who have fallen down in getting back on their feet.

When an elderly person or anyone who suffers from some other physical incapacity falls down, the problem with getting them upright can be insurmountable. Even with the aid of others, the task of lifting a person off of the floor can further injure the fallen person or those who are attempting to assist.

Falling is a very serious problem and the ramifications extend beyond the physical damage done by the fall itself. There is the fear of not being able to get upright, the embarrassment of having to call a 911 operator for assistance and the cost of calling for emergency assistance when there is no real need for medical attention.

Independence is a critical concern for the elderly or those who are incapacitated. People want to remain independent for as long as possible. The Helping Hand Chair would allow people who are concerned with falling and not being able to get back up the security of knowing that they will be able to recover from a fall with little or no outside assistance.

The Helping Hand Chair can be constructed so that it is not obtrusive and can easily fit, attractively, into a home environment or it can be made in a more industrial design and specification to accommodate a more universal need such as hospitals, nursing homes or any other facility of that type.

### BRIEF SUMMARY OF THE INVENTION

This invention, the Helping Hand Chair, effectively and efficiently resolves the problem with getting incapacitated or injured people off of the floor and into a seated position.

The Helping Hand Chair is a chair with lockable rollers and a seat that can be lowered to the floor and brought back up to a seated position. The chair is equipped with a mechanism that can be operated by either electricity, battery or hand gear, that will effectively lower/raise the seat to accommodate the fallen person. Retractable safety straps are positioned to secure the injured person onto the chair.

For convenience, the Helping Hand Chair can also be equipped with a variety of technical devices that will allow for the chair to be remotely called to the fallen person and a call for help device that can notify that assistance is needed.

The design of the Helping Hand Chair is not obtrusive and can fit into any decor or it can be made with a more industrial design for use in nursing homes, hospitals, etc.

### BRIEF DESCRIPTION OF THE SEVERAL VIEWS OF THE DRAWING

FIG. 1 is the Helping Hand Chair, three quarter view, depicting a conceptual likeness of the structure of the chair and how it can fit into every day life.

### DETAILED DESCRIPTION OF THE INVENTION

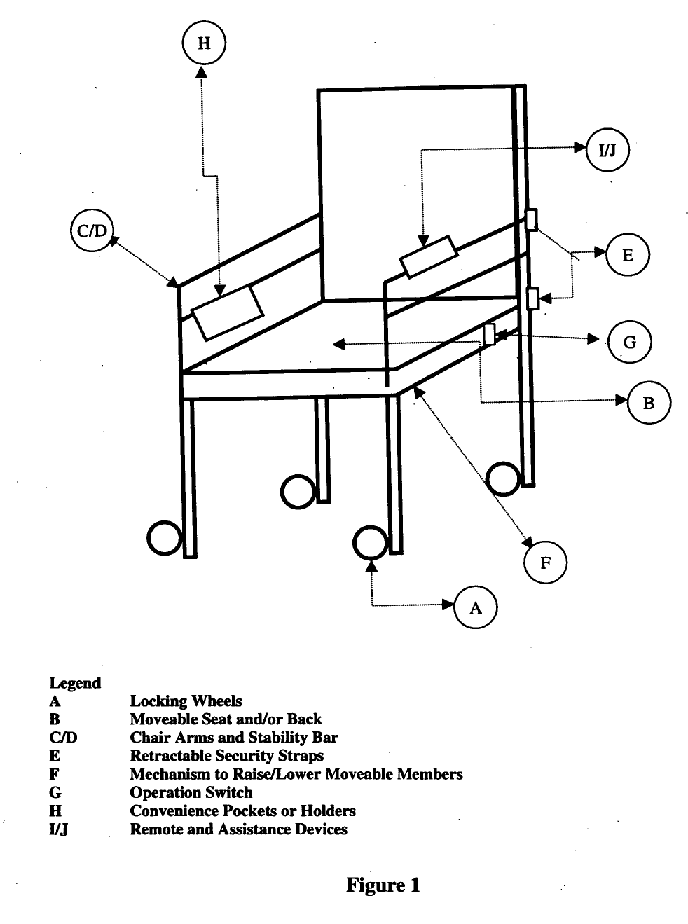

As shown in FIG. 1, the Helping Hand Chair comprises a chair frame with lockable rollers attached to the bottom of the four legs of the chair (FIG. 1-A). These wheels can rotate in any direction for ease of movement. Once the chair is in position for use, the wheels can be locked to stabilize the chair. These rollers will extend away from the legs allowing the seated portion to be lowered all the way to the ground.

The seated portion of the chair will raise and lower to allow for accessibility to the person who has fallen (FIG. 1-B). The seat portion will move up and down the chair legs. The seated portion can be either flat or can be beveled.

The arms of the chair will remain stationary as will the stability bar (FIG. 1-C/D).

Retractable safety belts are located near the seated portion and also near the back of the chair (FIG. 1-E).

Mechanism to raise and lower the seat is located in the rear and at the base of the chair (FIG. 1-F). The on/off button to operate the mechanism is ideally located in a convenient location and can be placed for the convenience of the owner of the chair (FIG. 1-G).

Pockets and other receptacles are available on the stationary portions of the chair to accommodate any variety of items from water bottles, necessary medical aids, tissues, etc. (FIG. I-H).

Electronic/mechanical or any device used to remotely retrieve the chair or to signal for assistance will be mounted in a convenient location on the chair (FIG. 1-I/J)

What I claim as my invention is:

1. Chair device having moveable supporting members

2. The chair of claim 1 wherein moveable members move vertically up and down supporting legs

3. The chair of claim 1 whereby lockable wheels are attached to supporting legs

4. The chair of claim 1 whereby safety straps are mounted

5. The chair of claim 1 whereby supporting arms are mounted.

6. The chair of claim 1 whereby stability bar is mounted

7. A chair device declared in claim 1 having an electronic/mechanical or any other technological device for raising, lowering, tilting, and rotating movable portions of said chair.

8. A mobile chair device whereby electronic/mechanical or any other technology is means for remote retrieval

9. A mobile chair device whereby electronic/mechanical or any other technology is means for signaling.
